(19) United States
(12) Patent Application Publication
(10) Pub. No.: US 2019/0392312 A1
(43) Pub. Date: Dec. 26, 2019

(54) METHOD FOR QUANTIZING A HISTOGRAM OF AN IMAGE, METHOD FOR TRAINING A NEURAL NETWORK AND NEURAL NETWORK TRAINING SYSTEM

(71) Applicant: Deep Force Ltd., Taipei City (TW)

(72) Inventors: Liu Liu, Taipei City (TW); May-Chen Martin-Kuo, Taipei City (TW); Yu-Ming Wei, Taipei City (TW)

(21) Appl. No.: 16/435,629

(22) Filed: Jun. 10, 2019

Related U.S. Application Data
(60) Provisional application No. 62/688,054, filed on Jun. 21, 2018.

(51) Int. Cl. G06N 3/08; G06F 17/18; G06N 3/04

(52) U.S. Cl. CPC G06N 3/08; G06N 3/0472; G06F 17/18

(57) ABSTRACT

A method for quantizing an image includes obtaining M batches of images; creating histograms by training based on each of the M batches of images; merging the histograms for each of the batches of images into a merged histogram; obtaining a minimum value from all minimum values of the M merged histograms and a maximum value from all maximum values of the M merged histograms; defining ranges of new bins of a new histogram according to the obtained minimum value, the obtained maximum value, and the number of the new bins; and estimating a distribution of each of the new bins by adding up frequencies falling into the ranges of the new bins to create the new histogram. The amount of the images in each of the M batches of images is N, and each of N and M is an integer and equal to or larger than two.

### CROSS-REFERENCE TO RELATED APPLICATION

This non-provisional application claims priority under 35 U.S.C. § 119(e) to U.S. Provisional Patent Application No. 62/688,054, filed on Jun. 21, 2018, the entire contents of which are hereby incorporated by reference.

### BACKGROUND

### Technical Field

The present invention relates to artificial intelligence (AI) and, in particular, relates to a method for quantizing a histogram of an image, method for training a neural network and neural network training system.

### Related Art

Most artificial intelligence (AI) algorithms need huge amounts of data and computing resource to accomplish tasks. For this reason, they rely on cloud servers to perform their computations, and aren't capable of accomplishing much at edge devices where the applications that use them to perform.

However, more intelligence technique is continually applied to edge devices, such as desktop PCs, tablets, smart phones and internet of things (IoT) devices. Edge device is becoming the pervasive artificial intelligence platform. It involves deploying and running the trained neural network model on edge devices. In order to achieve the goal, neural network training needs to be more efficient if it performs certain preprocessing steps on the network inputs and targets. Training neural networks is a hard and time-consuming task, and it requires horse power machines to finish a reasonable training phase in a timely manner.

At present, it is a very time consuming and memory consuming process to calculate histogram of the images to construct corresponding neural network due to the required large data storage capacity. Even to calibrate a very small neural network, one needs to save huge amount of data. Thus, it is hard to increase to larger scale data set/model. Write/Read huge data makes the process super slow.

### SUMMARY

In an embodiment, a method for quantizing an image includes obtaining M batches of images; creating histograms by training based on each of the M batches of images; merging the histograms for each of the batches of images into a merged histogram; obtaining a minimum value from all minimum values of the M merged histograms and a maximum value from all maximum values of the M merged histograms; defining ranges of new bins of a new histogram according to the obtained minimum value, the obtained maximum value, and the number of the new bins; and estimating a distribution of each of the new bins by adding up frequencies falling into the ranges of the new bins to create the new histogram. The amount of the images in each of the M batches of images is N, and M is an integer and equal to or larger than two, and N is an integer and equal to or larger than two.

In another embodiment, a method for training a neural network includes: receiving a plurality of input data; dividing the plurality of input data into M batches of input data, wherein M is an integer and equal to or larger than two; performing a training of a neural network based on each of the M batches of input data to obtain a plurality of output data; creating histograms of the output data for each of the M batches of input data; merging the histograms of the output data for each of the M batches of input data into a merged histogram; obtaining a minimum value from all minimum values of the M merged histograms and a maximum value from all maximum values of the M merged histograms; defining ranges of new bins of a new histogram according to the obtained minimum value, the obtained maximum value, and the number of the new bins; and estimating a distribution of each of the new bins by adding up frequencies falling into the ranges of the new bins to create the new histogram.

In yet another embodiment, a non-transitory computer-readable storage medium including instructions that, when executed by at least one processor of a computing system, cause the computing system to perform: receiving a plurality of input data; dividing the plurality of input data into M batches of input data, wherein M is an integer and equal to or larger than two; performing a training of a neural network based on each of the M batches of input data to obtain a plurality of output data; creating histograms of the output data for each of the M batches of input data; merging the histograms of the output data for each of the M batches of input data into a merged histogram; obtaining a minimum value from all minimum values of the M merged histograms and a maximum value from all maximum values of the M merged histograms; defining ranges of new bins of a new histogram according to the obtained minimum value, the obtained maximum value, and the number of the new bins; and estimating a distribution of each of the new bins by adding up frequencies falling into the ranges of the new bins to create the new histogram.

As above, the embodiments determines quantization according to the merged histograms, thereby reducing storage capacity, such as the amount of data to process is reduced significantly from 1M to 1000. In some embodiments, instead of saving raw data for each batch, the output histograms from batches can be combined, even when ranges of data vary.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below illustration only, and thus are not limitative of the present invention, and wherein:

FIG. 1 is a schematic view of a neural network training system according to an embodiment.

FIG. 2 is a flow chart of a method for quantizing an image according to an embodiment.

### DETAILED DESCRIPTION

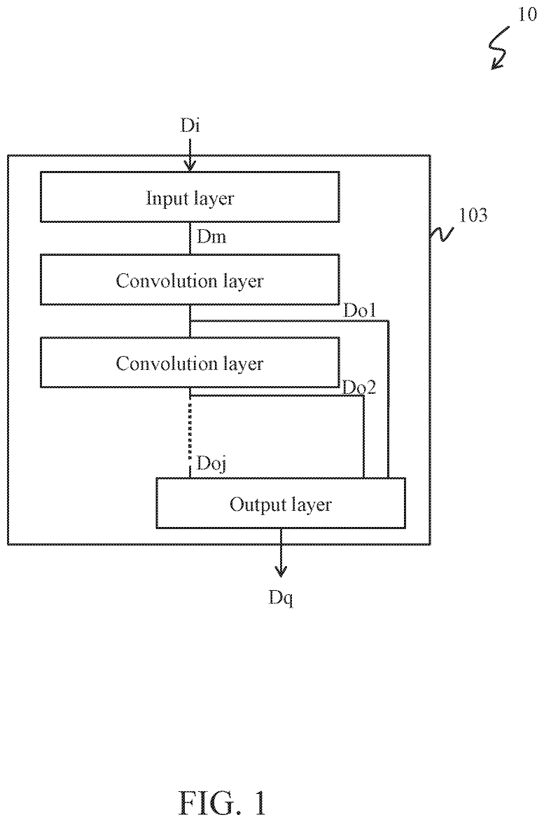

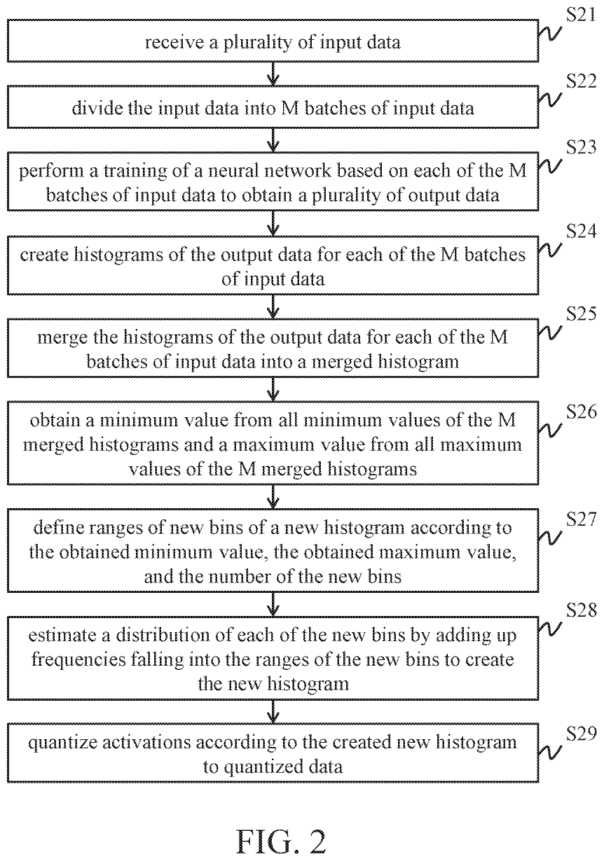

FIG. 1 is a schematic view of a neural network training system according to an embodiment. FIG. 2 is a flow chart of a method for quantizing an image according to an embodiment.

Referring to FIG. 1, the neural network training system 10 is adapted to execute a training based on an input data to generate a predicted result. The neural network training system 10 includes a neural network 103.

Refer to FIG. 1 and FIG. 2. In some embodiments, the neural network 103 can includes an input layer, one or more convolution layers and an output layer. The convolution layers are coupled in order between the input layer and the output layer. Further, if the number of the convolution layers is plural, each convolution layer is coupled between the input layer and the output layer.

The input layer is configured to receive a plurality of input data (Step S21), and divide the input data Di into M batches of input data Dm (Step S22). M is an integer and equal to or larger than two. The m is an integer between 1 and M. The amount of the data in each of the M batches of input data includes a plurality of the input data, such as N. N is an integer and equal to or larger than two. Preferably, the amount of the data (i.e. N) in each batch is equal to or larger than 100. In some embodiments, data type of the data in each batch is balanced. In some embodiments, the input data can be a plurality of images.

The convolution layers are configured to be trained based on each batch Dm to generate a plurality of output data Do (Step S23) and creates histograms of the output data Do1-Doj (Step S24). The j is an integer and equal to or larger than two. That is, the data in each batch are fed into the first layer of the convolution layers, and then each of the convolution layers is trained to generate an output data Doj. In some embodiments, the distribution of the output data Doj from each of the convolution layers can be saved as a histogram.

As to each batch, the output layer is configured to merge the histograms of the output data Do1-Doj from the convolution layers into a merged histogram (Step S25). After the training based on the M batches of input data D1˜Dm, the output layer obtains the M merged histograms and obtains a minimum value from all minimum values of the M merged histograms and a maximum value from all maximum values of the M merged histograms (Step S26).

The output layer defines ranges of new bins of a new histogram according to the obtained minimum value, the obtained maximum value, and the number of the new bins (Step S27). In some embodiments, the ranges of the new bins of the new histogram are decided by subtracting the obtained maximum value from the obtained minimum value and then dividing the number of the new bins. In some embodiments, the number of the new bins is depended on the desired number of bit of the trained result. For example, if the desired number of bit of the trained result is n, the number of the new bins is 2ⁿ. The n is an integer.

The output layer estimates a distribution of each of the new bins by adding up frequencies falling into the ranges of the new bins to create the new histogram (Step S28). In one embodiment, if the range of the new bin happens to be part of one of the old bins, assume distribution is a uniform distribution within each bin and get the proportion accordingly. In another embodiment, the distribution within each new bin is Gaussian, Rayleigh or normal distribution or others by characteristic data of images.

For example, no need to pre-define a range for histogram calculation. The range of the merged histogram for first batch is 10 to 100, and the range of the merged histogram for second batch is 1000 to 10000. Both histograms can be combined without loss of accuracy.

The output layer further quantizes activations according to the created new histogram Dq (Step S29). In some embodiments, if the amount of the data in each of the M batches of input data includes N, the activations is quantized according to the new combined histogram where CDF min is the minimum non-zero value of the cumulative distribution function (CDF) (in this case 1), M×N gives the image's number of pixels (for the example above 64, where M is width and N is the height), and L is the number of grey levels used.

As above, the embodiments determines quantization according to the merged histograms, thereby reducing storage capacity, such as the amount of data to process is reduced significantly from 1M to 1000. In some embodiments, instead of saving raw data for each batch, the output histograms from batches can be combined, even when ranges of data vary.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for quantizing an image, comprising:
obtaining M batches of images, wherein the amount of the images in each of the M batches of images is N, M is an integer and equal to or larger than two, and N is an integer and equal to or larger than two;
creating histograms by training based on each of the M batches of images;
merging the histograms for each of the batches of images into a merged histogram;
obtaining a minimum value from all minimum values of the M merged histograms and a maximum value from all maximum values of the M merged histograms;
defining ranges of new bins of a new histogram according to the obtained minimum value, the obtained maximum value, and the number of the new bins; and
estimating a distribution of each of the new bins by adding up frequencies falling into the ranges of the new bins to create the new histogram.

2. The method for quantizing the image of claim 1, further comprising:
quantizing activations according to the created new histogram.

3. The method for quantizing the image of claim 1, wherein the distribution of each of the new bins is selected by the group of Gaussian, Rayleigh, normal distribution or others by characteristic data of images.

4. The method for quantizing the image of claim 1, wherein the step of defining the ranges of the new bins of the new histogram according to the obtained minimum value, the obtained maximum value, and the number of the new bins comprises deciding the ranges of the new bins of the new histogram by subtracting the obtained maximum value from the obtained minimum value and then dividing the number of the new bins.

5. A method for training a neural network, comprising:
receiving a plurality of input data;
dividing the plurality of input data into M batches of input data, wherein M is an integer and equal to or larger than two;
performing a training of a neural network based on each of the M batches of input data to obtain a plurality of output data;
creating histograms of the output data for each of the M batches of input data;
merging the histograms of the output data for each of the M batches of input data into a merged histogram;
obtaining a minimum value from all minimum values of the M merged histograms and a maximum value from all maximum values of the M merged histograms;
defining ranges of new bins of a new histogram according to the obtained minimum value, the obtained maximum value, and the number of the new bins; and
estimating a distribution of each of the new bins by adding up frequencies falling into the ranges of the new bins to create the new histogram.

6. The method for training a neural network of claim 5, further comprising:
quantizing activations according to the created new histogram to quantized data.

7. The method for training a neural network of claim 6, further comprising:
performing the training of the neural network based on the quantized data.

8. The method for training a neural network of claim 5, wherein the distribution of each of the new bins is selected by the group of Gaussian, Rayleigh, normal distribution or others by characteristic data of images.

9. The method for training a neural network of claim 5, wherein the step of defining the ranges of the new bins of the new histogram according to the obtained minimum value, the obtained maximum value, and the number of the new bins comprises deciding the ranges of the new bins of the new histogram by subtracting the obtained maximum value from the obtained minimum value and then dividing the number of the new bins.

10. The method for training a neural network of claim 5, wherein the amount of the data in each of the M batches of input data is equal to or larger than 100.

11. The method for training a neural network of claim 5, wherein data type of the data in each of the M batches of input data is balanced.

12. A non-transitory computer-readable storage medium including instructions that, when executed by at least one processor of a computing system, cause the computing system to perform:
receiving a plurality of input data;
dividing the plurality of input data into M batches of input data, wherein M is an integer and equal to or larger than two;
performing a training of a neural network based on each of the M batches of input data to obtain a plurality of output data;
creating histograms of the output data for each of the M batches of input data;
merging the histograms of the output data for each of the M batches of input data into a merged histogram;
obtaining a minimum value from all minimum values of the M merged histograms and a maximum value from all maximum values of the M merged histograms;
defining ranges of new bins of a new histogram according to the obtained minimum value, the obtained maximum value, and the number of the new bins; and
estimating a distribution of each of the new bins by adding up frequencies falling into the ranges of the new bins to create the new histogram.
